(19) United States
(12) Patent Application Publication
(10) Pub. No.: US 2018/0235243 A1
(43) Pub. Date: Aug. 23, 2018

(54) PIE PREPARATION APPARATUS AND METHOD OF USE

(71) Applicant: Jon Smallegan, Melbourne, FL (US)

(72) Inventor: Jon Smallegan, Melbourne, FL (US)

(21) Appl. No.: 15/438,392

(22) Filed: Feb. 21, 2017

(51) Int. Cl. A21D 8/06; A21B 5/00; A47J 37/01

(52) U.S. Cl. CPC A21D 8/06; A47J 37/01; A21B 5/00

(57) ABSTRACT

Embodiments described herein provide a pie preparation apparatus and methods of using which includes a dimensioned non-stick baking pan having a plurality of laterally spaced triangular baking pockets along the top surface and at least one set of hexagon-shaped apertures. The apparatus further includes a hand-held crimping tool having a handle at the top and first and second hexagon-shaped male fitting at the first and second ends of the bottom end which are configured to be releasably inserted into the at least one set of hexagon-shaped apertures and provided a trimmed and crimped edge to a pie crust dough which is molded within the baking pockets and top surface. Once prepared, the dimensioned baking pan may be placed in at toaster oven for a desired period of time.

### FIELD

The present embodiment relates to a pie preparation apparatus, and in particular, to a pie preparation apparatus and method of use comprised of a dimensioned non-stick baking pan having a plurality of laterally spaced baking pockets and a plurality of hexagon or square shaped apertures located at the corners of each baking pocket which enable a hand-held crimping, sealing, cutting and trimming tool to be releasably guided by aligning the shaped apertures of the hand-held crimping tools within the correspondingly shaped first and second male fitting of the hand-held crimping tool to provide a highly efficient portable trimming and sealing device.

### BACKGROUND

Traditional pie baking has always been a tedious evolution in which a user must assemble the desired ingredients, mix, knead, roll and flour a pie crust, assemble in a pie pan and fluke/crimp, with the hope that the dough is properly sealed and then baked in the oven. This traditional method has been used for centuries and requires much skill and can be very intimidating to the new baker.

Many bakers have tried for centuries to create a tool or apparatus that allows for the convenient preparation of a pie crust to form individual or multiple pockets of pie. Many of these early inventions often led to the above-mentioned difficulties or allowed for the excess crust to be wasted along the edge of the baking pan or from cutting circles or triangles of dough from larger sheets.

Though there are several devices and apparatus available to prepare a pie crust such as U.S. Pat. App. No. 2013/0101719 to Brown; U.S. Pat. No. 3,296,956 to Wesley; and U.S. Pat. No. 3,831,507 to Wheaton, there is no single reference which discloses a pie preparation apparatus having a plurality of shaped baking cavities with shaped apertures at each corner which receive a correspondingly shaped male fitting.

### SUMMARY OF THE INVENTION

Embodiments described herein provide for a pie preparation apparatus and method of use which allows the user to efficiently prepare a pie crust using a non-stick baking pan and hand-held crimping tool. The non-stick baking pan includes a plurality of shaped baking pockets having shaped apertures located at each corner of the shaped baking pockets. These beveled and shaped apertures may be constructed in a square of hexagon and further correspond to the shape of the first male and second male fittings along the bottom of the hand-held crimping tool. For example, in the preferred embodiment the shaped baking pockets are constructed in equilateral triangles with hexagon-shaped apertures at each corner of the baking pockets. In this preferred embodiment only the hexagon-shaped first and second male fittings of the hand-held crimping tool will fit the apertures.

In an alternative embodiment, the plurality of shaped baking pockets is square shaped with square shaped apertures at each corner. In this alternative embodiment, only square shaped first and second male fitting will fit the apertures of this non-stick baking pan. Each of the plurality of shaped baking pockets have a uniformly thick sidewall and bottom surface. The top surface of the non-stick baking pan is substantially planar with each of the shaped aperture beveled to enable the user to insert and rock the hand-held crimping device within the aperture.

Further illustrated in an embodiment is a method of using the pie construction apparatus which include: placing a first folded half of pie crust over the top surface of the non-stick baking pan, inserting fill contents into the plurality of shaped baking pockets, placing the second folded half of pie crust over the first, inserting the first male fitting and second male fitting into the correspondingly shaped apertures located at each corner of shaped baking pockets, and depressing and rocking the hand-held crimping tool until the crust has been trimmed and a uniform crimp has been applied to the crust.

Other aspects, advantages, and novel features of the embodiments will become apparent from the following detailed description in conjunction with the drawings.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a perspective view of a pie construction apparatus;

FIG. 2 is a planar view of apparatus;

FIG. 3 is a cross-sectional view of the apparatus;

FIG. 4 is a cross-sectional view of the hand-held crimping tool;

FIG. 5 is an alternative view of the apparatus with triangular constructed shaped baking pockets; and

FIG. 6 is a flowchart illustrating a method of use.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

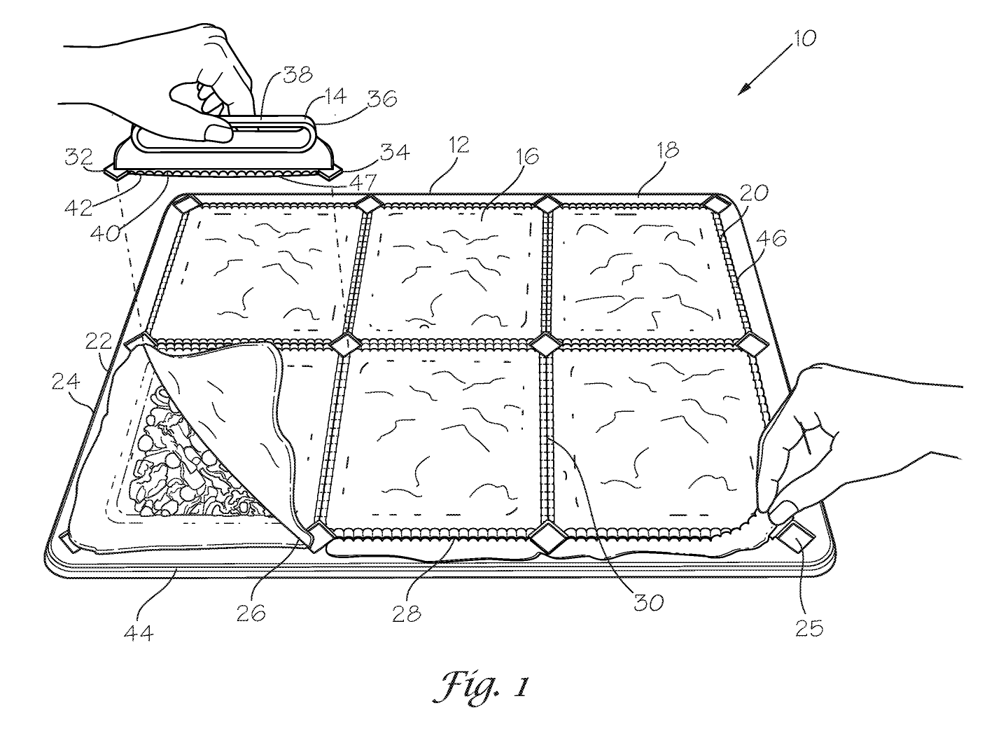

The embodiments provided illustrate a pie preparation apparatus and method of use which allows a user to prepare, trim, and crimp a pie crust for baking. The apparatus includes a non-stick baking pan having either square or triangular-shaped baking pockets. Further located at the corner of each baking pocket is a dimensioned and sloped aperture which is configured to fit a male and female fitting of a corresponding hand-held crimping tool. For example, shown in one embodiment (as depicted in FIG. 1) is the non-stick baking pan constructed with both square shaped baking pockets and apertures. When used in this embodiment only the square shaped first and second male fittings will fit within the square shaped apertures.

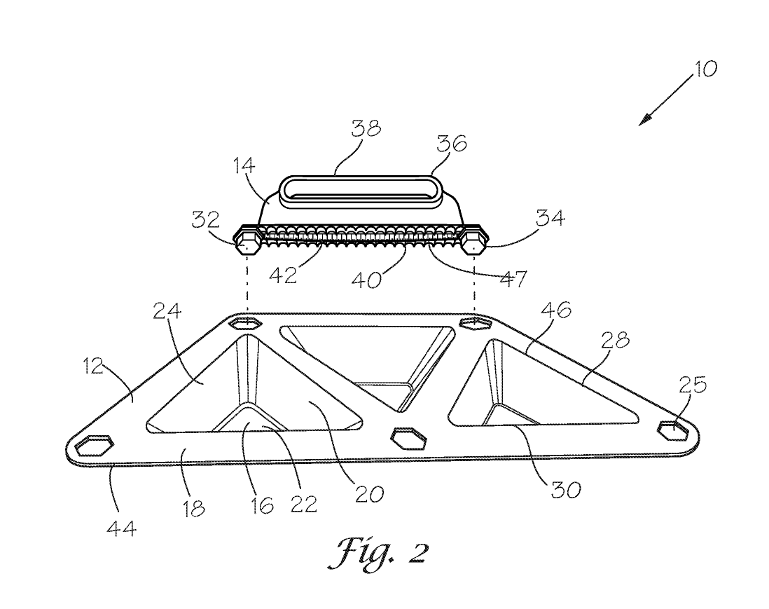

Conversely shown in FIG. 2, in the preferred embodiment, the shaped baking pockets are triangular shaped with hexagon-shaped apertures. When used according to this present embodiment only hexagon shaped first and second male fitting will fit within the shaped apertures.

Referring now to the drawings wherein like reference numerals designate identical or corresponding parts throughout the views. There is shown in FIG. 1 a pie preparation apparatus 10 which includes a dimensioned non-stick baking pan 12 and a hand-held portable crimping tool 14. In the current embodiment, the dimensioned non-stick baking pan 12 is square shaped with both the plurality of shaped baking pockets 16 and shaped apertures 25 located at each corner 26 along the top surface 18 are square shaped. Each of the plurality of baking pockets 16 includes a sidewall 20 sloped downward from the substantially planar top surface 18 to the parallel bottom surface 22. The uniform sidewall 20 further defines the height of the apparatus 24 and allows the convectional oven to provide a uniform heating to the content within the plurality of shaping baking pockets.

As illustrated in FIG. 1, the square shaped apertures 25 are slightly beveled to align and guide the hand-held crimping tool 14. The lateral spacing of these square shaped apertures 25 further defines the length 28 and width 30 of each of the equilateral shaped plurality of baking pockets 16. It is contemplated that the non-stick baking pan 12 is comprised of at least a single thick aluminum or steel material having a light or dark coloration. However, any single thick high durometer material may be used as long it contains a non-stick coating along the top surface 18 and provide a uniform heating to the plurality of shaped baking pockets 16.

The hand-held crimping tool 14 enables the user to trim, seal, crimp and cut each edge around the plurality of shaped baking pockets 16. The hand-held crimping tool 14 further includes a molded and ergonomic handle 36 at the top end 38 and a indented portion 40 between the first male fitting 34 and second male fitting 36 along the bottom surface. Further located between the first male fitting 34 and second male 36 is an elongated trimming blade 42 which allows the user to cut any excess dough around the perimeter of the non-stick baking pan.

Shown in FIG. 2, the preferred embodiment, is the non-stick baking pan 12 with the plurality of shaped baking pockets 16 constructed with equilateral triangles. Each corner 26 of the shaped baking pockets 16 includes a beveled and hexagon-shaped aperture 25 which align and guide the hexagon-shaped first male 34 and second male 36 fitting of the hand-held crimping tool 14.

Further illustrated in FIG. 2 is a view of the trimming blade 42 of the hand-held crimping tool 14. The trimming blade 42 having a length defined as the distance between the first 34 and second 36 male fittings. When the first 34 and second 36 male fitting are inserted within the shaped aperture 25, the trimming blade 42 and indented (i.e., grooved) portion trim the excess dough along the perimeter of the non-stick baking pan 12 and provide a uniform crimp along the edge of the pie crust. A further advantage of the beveled and shaped aperture 25 provide is to allow a user to depress and rock hand-held crimping tool when releasably inserted within the shaped apertures 25.

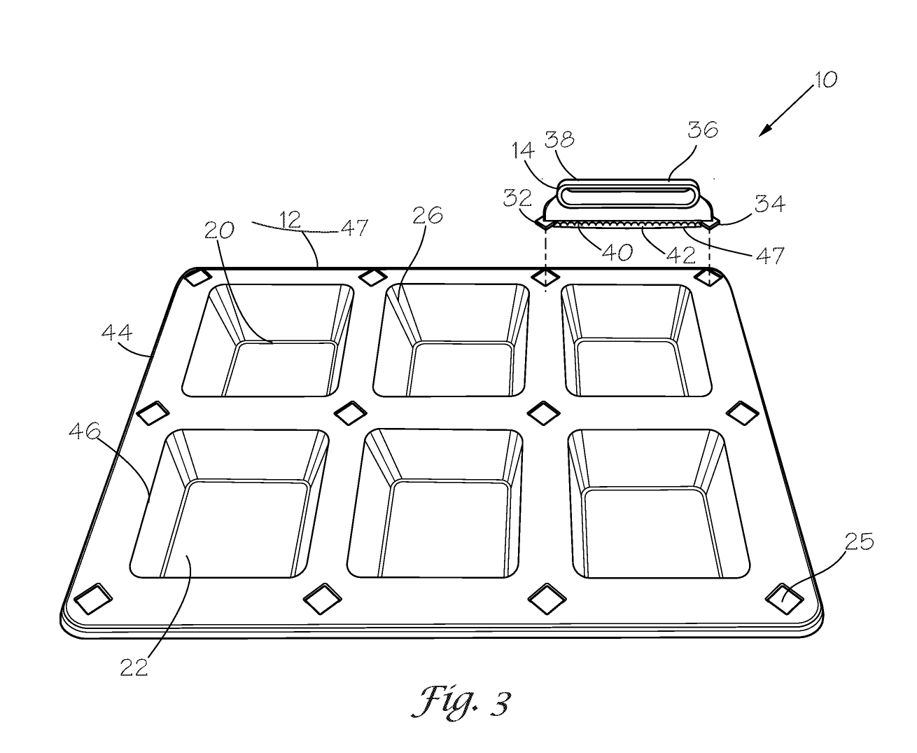

Now shown in FIG. 3 is a further view of the alternative embodiments wherein the plurality of baking pockets 16 and beveled and shaped apertures 25 are square. In this present embodiment, the first 34 and second 36 male fitting must be square shaped and would not allow a hexagon shaped first 34 and second 36 male fitting to be received by the apertures 25 of the non-stick baking pan.

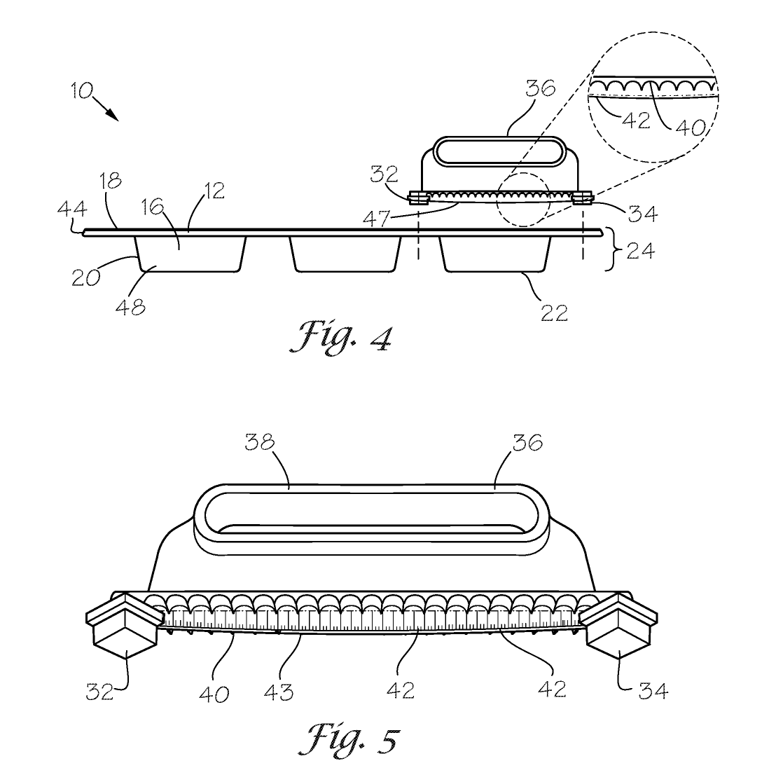

Now shown in FIG. 4 and FIG. 5 is a side view of the apparatus 10 and detailed view the hand-held crimping tool 14 respectively. Though it is contemplated the hand-held crimping tool 14 is comprised of a plastic material, any flexible non-stick plastic substitute may be used as long its machine washable and BPA-free.

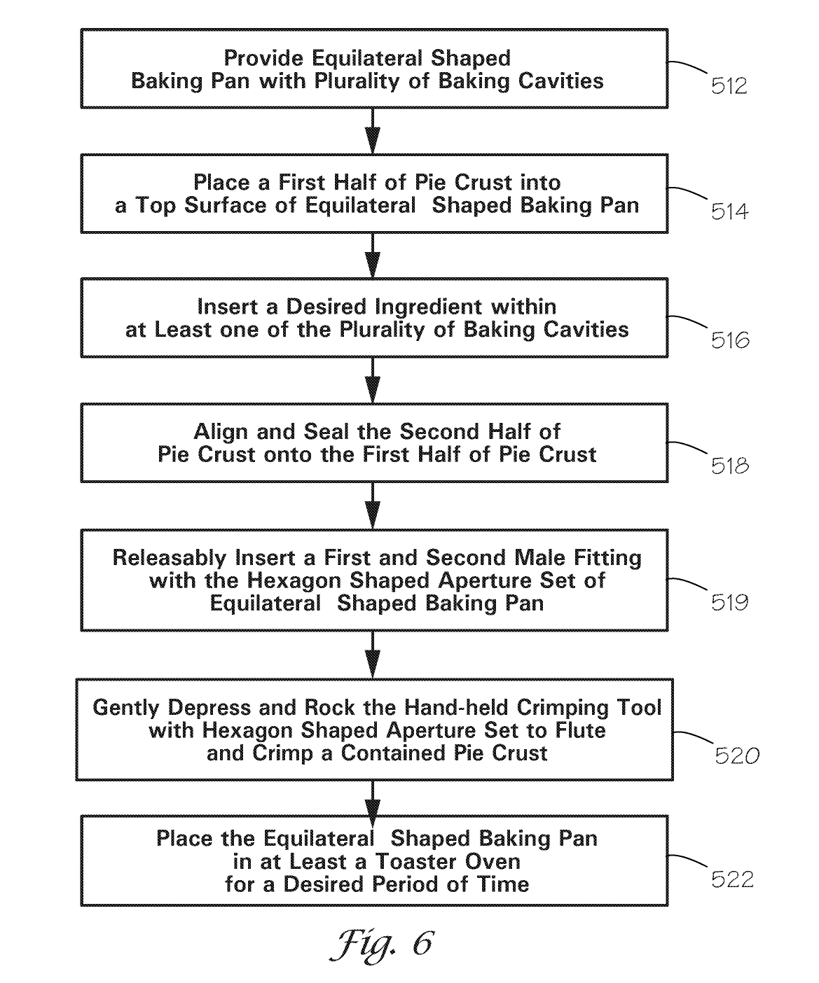

Now shown in FIG. 6 is a flowchart illustrating a method of preparing a pie crust for baking 510 by placing a first folded half of pie crust over the top surface of the non-stick baking pan 514. Once the first folded half is uniformly applied along the top surface 514, the user may then insert their desired ingredients (i.e., contents) into the plurality of shaped baking pockets 516. Upon filling, the user may then place the second folded half of pie crust over the first folded half and insert the first male 32 and second male fitting 34 within the beveled and shaped aperture 25 located at the corner of each of the plurality of shaped baking pockets 516.

It will be appreciated by persons skilled in the art that the present embodiment is not limited to what has been particularly shown and described hereinabove. In addition, unless mention was made above to the contrary, it should be noted that all of the accompanying drawings are not to scale. A variety of modifications and variations are possible in light of the above teachings without departing from the following claims.

What is claimed is:

1. A pie preparation apparatus, the apparatus comprising:
a non-stick baking pan dimensioned to fit within a toaster oven having a plurality of equilaterally-shaped baking pockets further including a shaped aperture at each corner of the equilaterally-shaped baking pockets which enable a hand-held crimping tool to be releasably inserted to trim and crimp a pie crust; and
a hand-held crimping tool having a first and a second shaped male fitting along a bottom surface; the first and second shaped male fitting corresponding to the shaped aperture of the non-stick baking pan.

2. The apparatus of claim 1, wherein the shaped apertures further include a beveled orientation about a top surface of the non-stick baking.

3. The apparatus of claim 1, wherein the plurality of equilaterally-shaped baking pockets includes a triangle

4. The apparatus of claim 1, wherein the plurality of equilaterally-shaped baking pockets includes a square.

5. The apparatus of claim 1, wherein the hand-held crimping tool further includes an indented portion between the first male fitting and the second male fitting to provide a trimmed edge along a perimeter of the non-stick baking pan.

6. The apparatus of claim 5, wherein the hand-held crimping tool further includes a bottom surface having an elongated and trimming blade.

7. The apparatus of claim 6, wherein the length of the elongated trimming blade is defined by a distance between the first male fitting and the second male fitting.

8. The apparatus of claim 6, wherein the hand-held crimping tool further includes a handle portion.

9. A pie construction apparatus, the apparatus comprising:
a non-stick baking pan dimensioned to fit within a toaster oven and further including a plurality of shaped baking pockets; each of the plurality of shaped baking pockets having a shaped and beveled aperture to receive a shaped male and a female fitting of a hand-held crimping tool; and
a hand-held crimping tool including:
a molded and ergonomic handle;
a first and second male fitting at a bottom surface; the first and second male fitting corresponding to the shaped and beveled aperture of the non-stick baking pan;
a trimming blade extending between the first and the second male fitting.

10. The apparatus of claim 9, wherein the plurality of shaped baking pockets further includes an equilateral triangle.

11. The apparatus of claim 9, wherein the plurality of shaped baking pockets further includes a square.

12. The apparatus of claim 8, wherein the hand-held crimping tool further includes a grooved portion along a bottom surface to provide a crimped edge to a pie crust.

13. A method of preparing a pie crust, the method comprising:
providing a non-stick baking pan dimensioned to fit in at least a toaster oven and having a plurality of shaped baking pockets; each corners of the plurality of shaped baking pockets having a beveled and shaped aperture to receive a correspondingly shaped first and second male fitting of a hand-held crimping tool;
placing a first folded half of a pie crust onto the top surface of the non-stick baking pan;
inserting at least one ingredient within at least one of the plurality of shaped baking pockets;
covering and sealing the at least one of the plurality of plurality of shaped baking pockets with a second folded half of pie crust;
inserting a shaped first and a second male fitting of a hand-held crimping tool within the correspondingly shaped aperture of the non-stick baking pan to trim and crimp the folded first and second half of pie crust;
placing the non-stick baking pan within at least a toaster oven for a selected period of time.

14. The method of claim 13, wherein the plurality of shaped baking pockets further includes an equilateral triangle.

15. The methods of claim 14, wherein the plurality of shaped baking pockets further includes a square.

16. The method of claim 15, wherein the hand-held crimping tool further includes a trimming blade extending along a bottom surface between the shaped first and second male fitting.
